(19) United States
(12) Patent Application Publication
(10) Pub. No.: US 2008/0281576 A1
(43) Pub. Date: Nov. 13, 2008

(54) INTERFACE BOARD, SIMULATOR, SYNCHRONIZATION METHOD, AND SYNCHRONIZATION PROGRAM

(75) Inventors: Toshiyuki Ohno, Tokyo (JP); Akira Ishitsuka, Tokyo (JP); Shogo Ishii, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA SOLUTIONS CORPORATION, Tokyo (JP)

(21) Appl. No.: 12/111,603

(22) Filed: Apr. 29, 2008

(30) Foreign Application Priority Data
May 11, 2007 (JP) 2007-126314

(51) Int. Cl. G06G 7/62

(52) U.S. Cl. 703/21

(57) ABSTRACT

There is provided an interface board which synchronizes processings between a CPU board mounting a CPU and peripheral hardware models of peripheral hardware components modeled on a computer. The interface board connects a CPU board and a peripheral hardware simulator with each other. The CPU board has at least one CPU, and the peripheral hardware simulator simulates operation of at least one peripheral hardware component by a peripheral hardware model. The interface board includes: a wait instruction unit that receives an interruption notification from the CPU, then notifies the peripheral hardware model of the interruption notification, and sets the CPU into a wait state; and a release unit that releases the wait state in which the CPU has been set by the wait instruction unit, upon reception of an instruction to release the wait state from the peripheral hardware model which has been notified of the interruption notification.

### BACKGROUND OF THE INVENTION

1. Field of the Invention

The present invention relates to an interface board, a synchronization method, and a synchronization program for synchronizing a processing performed by a CPU with a processing performed by a peripheral hardware model which simulates operation of a peripheral hardware component. The present invention also relates to the simulator.

2. Description of the Related Art

In case of testing operation of a target product which is planned to be commercially produced, the target product should desirably be manufactured and tested by actually manufacturing just the same configuration as what the target product is designed. However, due to limitations of manufacturing costs and the number of manufacturing processes, operation tests are carried out by a simulator which is configured to simulate some parts of the target product by hardware and other parts by software, in many cases. With a simulator having such a configuration, operation tests need to be carried out with the hardware and the software synchronized with each other to align the time axes.

According to related conventional arts relevant to the present invention, there is a known system simulator in which a program for an electronic device using a microcomputer and a hardware component are tested integrally by a simulation device (for example, see Patent Document 1: Jpn. Pat. Appln. Laid-Open Publication No. 2000-35898). The system simulator includes a hardware simulator, a virtual model simulator, and a CPU model simulator. The hardware simulator tests a hardware component as a software component based on the program. The virtual model simulator processes program commands of the program related to the hardware component, through processings equivalent to those performed by the hardware component. The CPU model simulator tests the program by software while appropriately utilizing output from the hardware simulator or the virtual model simulator.

However, there is no effective method for synchronizing processings between a CPU board and peripheral hardware models, in a simulator having a configuration in which a CPU is constructed as hardware as the CPU board, and other peripheral components are modeled (constructed as software components).

According to Patent Document 1, the whole of the system simulator is constituted as software which runs on a simulation device. The Patent Document 1 therefore neither discloses nor implies synchronization of processings between hardware and modeled devices (each constituted as software).

### SUMMARY OF THE INVENTION

The present invention has been made in view of the problems described above, and has an object of providing an interface board, a synchronization method, and a synchronization program, which synchronize processings performed by a CPU board mounting a CPU and processings performed by peripheral hardware models constituted by modeling other peripheral hardware components by a computer. The present invention also has an object of providing a simulator including the CPU board, a peripheral hardware simulator which executes peripheral hardware modeling, and the interface board.

According to one aspect of the present invention to solve the objects described above, there is provided an interface board for connecting a CPU board and a peripheral hardware simulator with each other, the CPU board having at least one CPU, the peripheral hardware simulator simulating operation of at least one peripheral hardware component by a peripheral hardware model, and the interface board including: a wait instruction unit that receives an interruption notification from the CPU, then notifies the peripheral hardware model of the interruption notification, and sets the CPU into a wait state; and a release unit that releases the wait state in which the CPU has been set by the wait instruction unit, upon reception of an instruction to release the wait state from the peripheral hardware model which has been notified of the interruption notification.

In order to solve the above object, the interface board described above further includes a dual port memory which is accessible from the CPU board and the peripheral hardware simulator, wherein upon access to a predetermined area in the dual port memory, the wait instruction unit notifies the peripheral hardware model of the interruption notification and sets the CPU into the wait state.

In order to solve the above objects, the interface board described above is connected to the peripheral hardware simulator by a PCI bus.

According to another aspect of the present invention to solve the above object, there is provided a simulator including: a CPU board that has at least one CPU; a peripheral hardware simulator that simulates operation of at least one peripheral hardware component by a peripheral hardware model; a wait instruction unit that receives an interruption notification from the CPU, then notifies the peripheral hardware model of the interruption notification, and sets the CPU into a wait state; and a release unit that releases the wait state in which the CPU has been set by the wait instruction unit, upon reception of an instruction to release the wait state from the peripheral hardware model which has been notified of the interruption notification.

Also to solve the above objects, the simulator described above further includes a dual port memory which is accessible from the CPU board and the peripheral hardware simulator, wherein upon access to a predetermined area in the dual port memory, the wait instruction unit notifies the peripheral hardware model of the interruption notification and sets the CPU into the wait state.

Also to solve the above objects, the wait instruction unit and the release unit are connected to the peripheral hardware simulator by a PCI bus, in the simulator described above.

According to still another aspect of the present invention to solve the above objects, there is provided a synchronization method for synchronizing a CPU and at least one peripheral hardware model with each other, the at least one peripheral hardware model modeling a peripheral hardware component as a software component, and the synchronization method including: a wait instruction step that, upon reception of an interruption notification from the CPU, notifies the peripheral hardware model of the interruption notification and sets the CPU into a wait state; and a release step that releases the wait state in which the CPU has been set in the wait instruction step, upon reception of an instruction to release the wait state from the peripheral hardware model which has been notified of the interruption notification.

Also to solve the above objects, the wait instruction step notifies the peripheral hardware model of the interruption notification and sets the CPU into the wait state, upon access to a predetermined area in a dual port memory which is accessible from a CPU board including the CPU and from a peripheral hardware simulator causing the peripheral hardware model to work, in the synchronization method described above.

Also to solve the above objects, the wait instruction step and the release step are executed by an interface board which connects the CPU board including the CPU and the peripheral hardware simulator causing the peripheral hardware model to work with each other and the interface board is connected to the peripheral hardware simulator by a PCI bus, in the synchronization method described above.

According to still another aspect of the present invention, there is provided a synchronization program for causing a computer to execute a synchronization processing for synchronizing a CPU and at least one peripheral hardware model with each other, the at least one peripheral hardware model modeling a peripheral hardware component as a software component, and the synchronization program including: a wait instruction step that, upon reception of an interruption notification from the CPU, notifies the peripheral hardware model of the interruption notification and sets the CPU into a wait state; and a release step that releases the wait state in which the CPU has been set in the wait instruction step, upon reception of an instruction to release the wait state from the peripheral hardware model which has been notified of the interruption notification.

According to the present invention, synchronization of processing can be maintained between a CPU board and peripheral hardware models.

### BRIEF DESCRIPTION OF THE DRAWINGS

FIG. 1 is a diagram showing a configuration of a simulator according to an embodiment of the present invention;

FIG. 2 is a diagram showing functional blocks of a PCI board according to the embodiment of the present invention;

FIG. 3 shows register function allocation and corresponding registers, according to the embodiment of the present invention; and

FIG. 4 shows a processing sequence according to the embodiment of the present invention.

### DETAILED DESCRIPTION OF THE PREFERRED EMBODIMENTS

Hereinafter, an embodiment of the present invention will be described referring to the drawings. The embodiment will be described as a simulator supposing a case of simulating a device which performs JPEG compression on uncompressed image data.

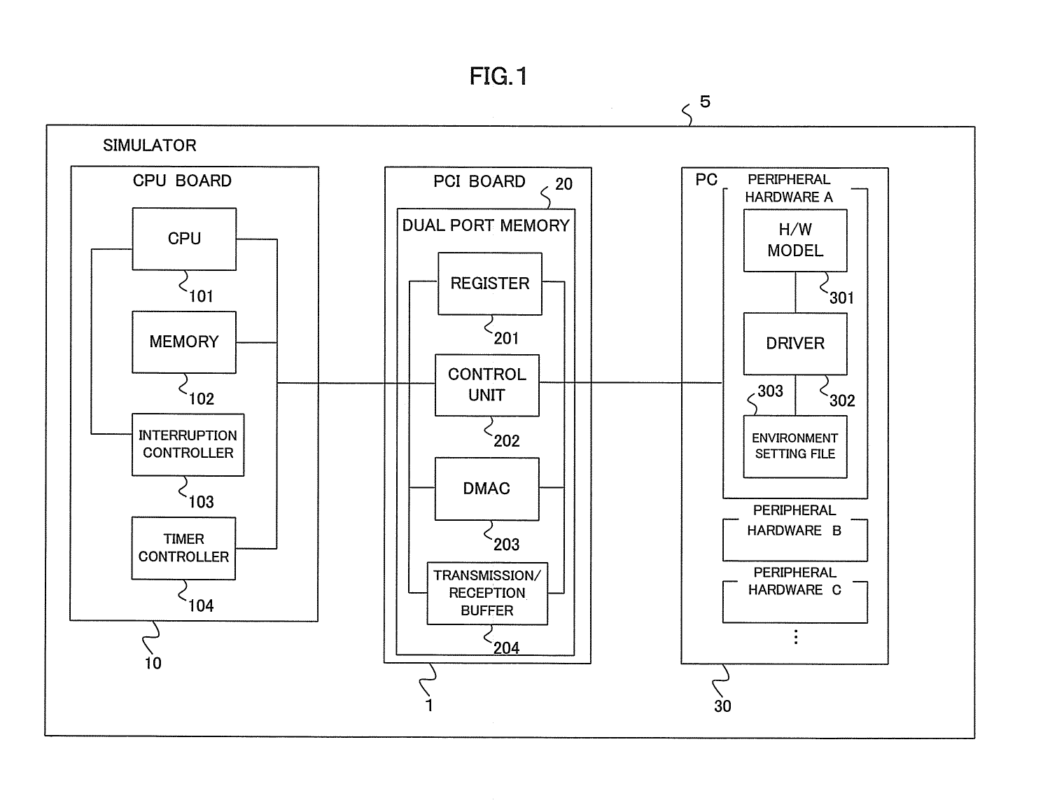

FIG. 1 shows a configuration of a simulator according to the embodiment.

A simulator 5 includes a CPU board 10, a PCI board 1 as an interface board, and a PC (Personal Computer) 30 as a peripheral hardware simulator that simulates operation of peripheral hardware.

The CPU board 10 is a board which at least has a CPU on a board. The CPU board according to the present embodiment includes, as least necessary components constituting a device configuration thereof: a CPU 101; a memory 102 (RAM or ROM); an interruption controller 103 which generates an interruption signal; a timer controller 104 which performs time management; a phase synchronization circuit PLL; and a reset circuit RSET.

The PCI board 1 is an interface board which functions to connect the CPU board 10 with the PC 30 and to serve as an intermediate buffer between the CPU board 10 and the PC 30. The PCI board 1 has a dual port memory 20 which can be accessed from both the CPU board 10 and the PC 30. The dual port memory 20 is internally configured to include a register 201, a control unit 202, a DMAC (Direct Memory Access Controller) 203, and a transmission/reception buffer 204. The PCI board 1 is connected by a bus connection to the CPU board 1 and to the PC 30 by a PCI connection.

The PC 30 includes a peripheral hardware model 301 (denoted as H/N model in FIG. 1), a driver 302, and an environment setting file 303. The peripheral hardware model 301 models a JPEG compression device as a software component. The driver 302 is used to control the peripheral hardware model 301. The PC 30 deals with a set of the peripheral hardware model 301, driver 302, and environment setting file 303, as one peripheral hardware component (denoted as peripheral H/W A, peripheral H/W B, . . . in FIG. 1).

The register 201 according to the embodiment is internally set up as two registers, i.e., an interruption event generation register and an interruption/WAIT event generation register. Next, a description will be made of operation in case of access is made from these registers.

Upon access to an address range in the register 201 which is set for the interruption event generation register, the PCI board 1 notifies the peripheral hardware model 301 of an interruption. Values which are set in an address range of the interruption event generation register take 0 as an initial value. At the initial value of 0, no interruption occurs.

Upon access to an address range in the register 201 which is set up for the interruption/WAIT event generation register, the PCI board 1 notifies the peripheral hardware model 301 of an interruption. At the same time, the CPU 101 waits until the peripheral hardware model 301 gives an instruction about a release from a wait (WAIT). Values which are set in an address range of the interruption/WAIT event generation register take 0 as an initial value. At the initial value of 0, neither interruption nor WAIT occurs.

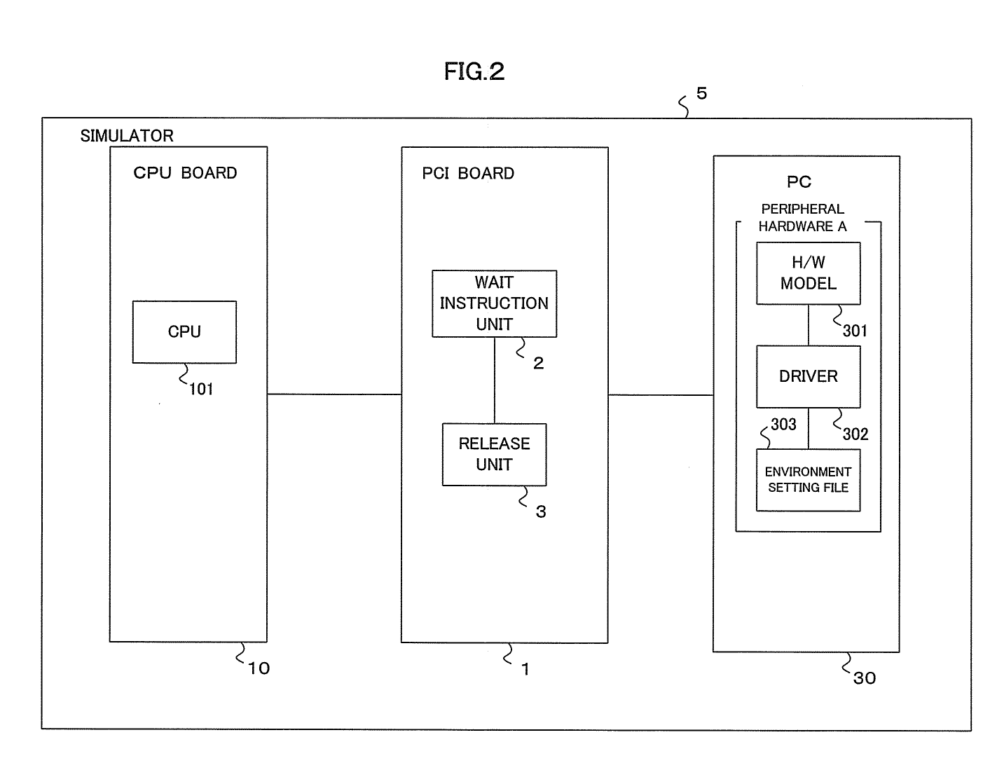

Next, FIG. 2 shows a functional block diagram of the PCI board 1.

The CPU board 1 includes: a wait instruction unit 2 which notifies the peripheral hardware model 301 of the PC 30 of an interruption notification upon reception of an interruption notification from the CPU board 10, and causes the CPU 101 on the CPU board 10 to wait; and a release unit 3 which releases a wait state of the CPU 101 caused to wait by the wait instruction unit 2 upon reception of an instruction about a release from a wait state. The instruction about the release is received from the peripheral hardware model 301.

The wait instruction unit 2 and the release unit 3 are activated to operate upon an external access from a predetermined register in the register 201.

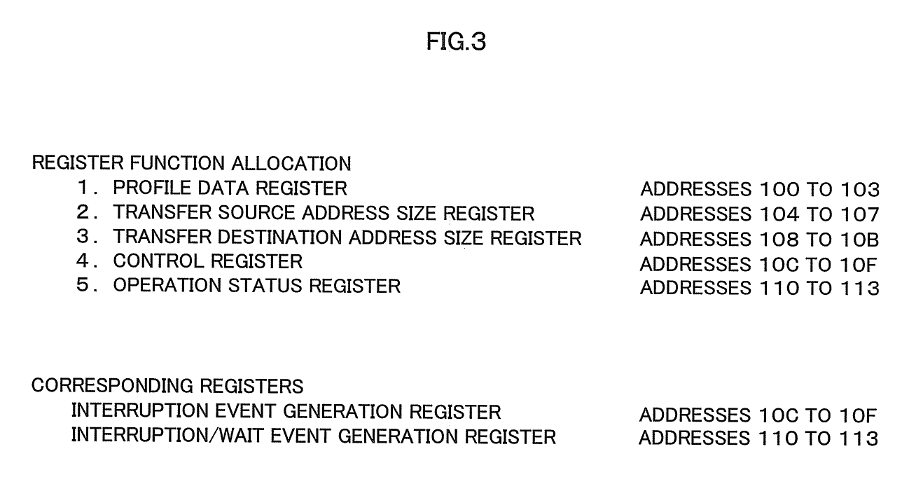

FIG. 3 shows “Register Function Allocation” about how functions of the register 201 for performing JPEG compression are allocated.

A profile data register, a transfer source address register, and a transfer destination address register contain information which is to be transferred to the peripheral hardware model 301 from the CPU board 10 and is used for performing JPEG compression. In this embodiment, the profile data register contains setting information such as a JPEG compression rate. The transfer source address register indicates an address of uncompressed image data (or in other words, image data before processing). The transfer destination address register indicates an address of image data after JPEG compression.

A control register controls a JPEG compression such as conversion start. An operation status register contains a processing state of the peripheral hardware model 301, such as “running” or “conversion error”.

In this embodiment, the address range as shown in the “Register Function Allocation”, a range of addresses 100 to 103 is allocated to the profile data register. A range of addresses 104 to 107 is allocated to the transfer source address register. A range of addresses 108 to 10B are allocated to the transfer destination address register. A range of addresses 10C to 10F is allocated to the control register. A range of addresses 110 to 113 is allocated to the operation status register.

As shown in FIG. 3 of “Corresponding Registers”, addresses 10C to 10F are allocated to the interruption event generation register, and addresses 110 to 113 are allocated to the interruption/WAIT event generation register. By setting up addresses in this manner, an interruption event is issued to the peripheral hardware model 301, upon access made to the control register (starting from an address 10C). Upon access to the operation status register (starting from an address 110), an interruption event is issued to the peripheral hardware model 301, and a WAIT event is issued simultaneously to the CPU 101.

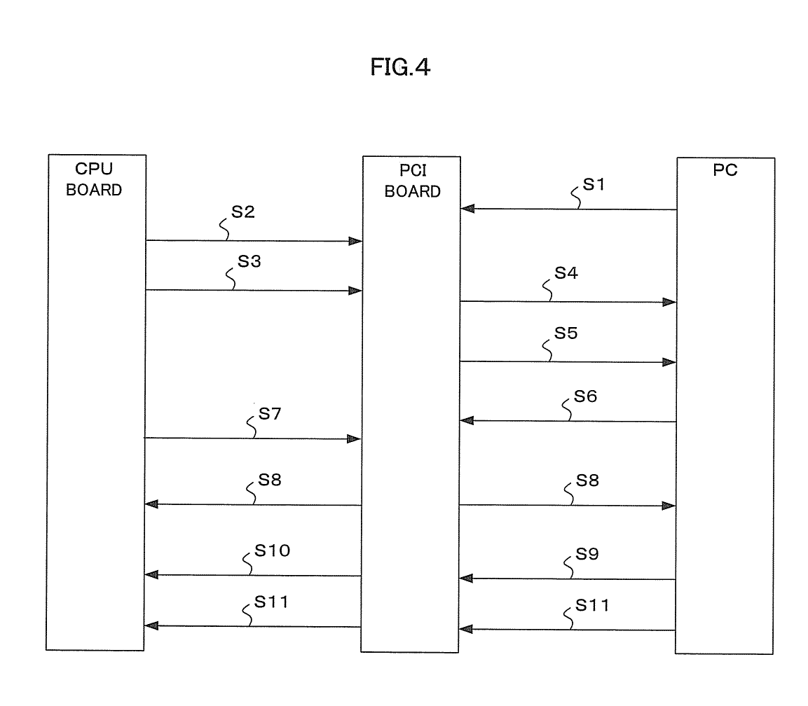

Next, a JPEG compression according to this embodiment will be described with reference to FIG. 4.

At first, the PCI board 1 loads information of the environment setting file 303 in advance as an initial setting into the control unit 202 (Step S1). The environment setting file 303 contains information shown in FIG. 3 described above, and the control unit 202 sets up and controls the dual port memory, based on the information.

The CPU board 10 sets profile data, a transfer source address, and a transfer destination address respectively in the profile data register, transfer source address register, and transfer destination address register in the register 201 (Step S2). In this embodiment, the profile data, transfer source address, and transfer destination address are contained in the memory 102, and can alternatively be defined in the environment setting file 303.

The CPU 101 sets a value for starting the JPEG conversion in the control register in the register 201, in order to cause the peripheral hardware model 301 to start a JPEG conversion (Step S3).

Since the control register allocated for the an event generation register is accessed from the CPU 101, the PCI board 1 issues an interruption notification to the peripheral hardware model 301 through the driver 302 (Step S4).

The peripheral hardware model 301 receives the interruption notification then checks content set in the control register in the register 201. If the content is a value for starting the JPEG conversion, the peripheral hardware model 301 reads the profile data, transfer source address, and transfer destination address respectively from the profile data register, transfer source address, and transfer destination address in the register 201 (Step S5).

Thereafter, the peripheral hardware model 301 requests DMA (Direct Memory Address) from the DMAC 203 of the PCI board 1. The DMAC 203 which has received the request for DMA spreads uncompressed image data onto the memory of the PC 30 where the peripheral hardware model 301 performs processings, via the transmission/reception buffer of the PCI board 1 from the memory 102 of the CPU board 10.

The peripheral hardware model 301 starts a compression calculation and sets a pre-allocated value in the operation status register in the register 201 (Step S6)

A value indicating processing content (such as running or a conversion error) of the peripheral hardware model 301 and a flag are set in the operation status register. The flag indicates whether a processing requires synchronization between the peripheral hardware model 301 and the CPU 101 or not. This embodiment supposes that a processing which requires synchronization is carried out now and a synchronization-need flag is set in Step S6.

The CPU 101 accesses the operation status register in the register 201 in order to read operation status (Step S7)

Since the register (e.g., the operation status register) corresponding to the interruption/WAIT event generation register has been accessed and a synchronization-need flag is set, the PCI board 1 notifies the peripheral hardware model 301 of an interruption through the driver 302 and simultaneously causes the CPU 101 to wait (WAIT) (Step S8).

If the processing which requires synchronization with the CPU 101 ends afterward, the peripheral hardware model 301 sets a value indicating processing content and a synchronization-free flag in the operation status register, and further issues a WAIT release command (Step S9).

The PCI board 1 receives the WAIT release command and further releases the CPU 101 from WAIT (Step S2). The CPU 101 is released from WAIT, and reads processing content which has been set in the operation status register by the peripheral hardware model 301. Since a synchronization-free flag is set in the operation status register, the CPU 101 does not wait.

Release of the CPU 101 from WAIT by the PCI board 1 may alternatively be carried out in a manner as follows. That is, a WAIT release register is separately set in the register 201 in advance. The WAIT release register is accessed by a WAIT release command issued from the peripheral hardware model 301. This access is detected by the CPU 101, which is thereby released from WAIT.

Upon completion of the JPEG compression calculation, the peripheral hardware model 301 reads the transfer destination address as described above, and requests DMA from the DMAC 203 in the PCI board 1. The DMAC 203 which has received the request for DMA spreads JPEG compression image data onto the memory of the PC 30 where the peripheral hardware model 301 performs processings, via the transmission/reception buffer of the PCI board 1 from the memory 102 of the CPU board 10.

The peripheral hardware model 301 sets a value indicating normal completion as processing content in the operation status register in the register 201, also sets a synchronization-free flag, and issues an interruption request command to the CPU 101 (Step S11). The CPU 101 receives the interruption request command and then reads a value indicating processing content which is set in the operation status register, thereby to confirm that the processing has been normally completed by the peripheral hardware model 301.

As an alternative configuration, the whole area of the dual port memory 20 may be divided into divisional areas corresponding respectively to sets of peripheral hardware (peripheral H/W A, peripheral H/W B, . . . ). For each of the divisional areas, WAIT of the CPU 101 and an interruption notification to a corresponding peripheral hardware model may be issued. With this configuration, plural sets of peripheral hardware and the CPU 101 can be synchronized with each other. Accordingly, a target product which includes plural sets of peripheral hardware can be totally tested.

In this embodiment, the address range of the operation status register and the address range of the interruption/WAIT event generation register are the same as each other, and a WAIT control of the CPU 101 is made by using synchronization-need flag and synchronization-free flag. Alternatively, however, a broader address range than the address range of the interruption/WAIT event generation register may be allocated to the operation status register. When synchronization is not required, access may be made to an area which is included in the address range of the operation status register but is excluded from the address range of the interruption/WAIT event generation register.

According to this embodiment, test can be carried out with time axes aligned with each other (i.e., in an environment close to an actual operation state). In addition, the PCI board 1 according to this embodiment can cause a CPU to wait in a processing which requires synchronization. Therefore, the CPU and a peripheral hardware model can be synchronized with each other.

Further in the embodiment, a synchronization program has been described as being pre-installed in the interface board as described previously. The synchronization program according to the present invention may, however, be stored in a storage medium. The storage medium may be any of all types of media which can be read from and executed by a computer in the device described previously. Examples of such media are those media which can be attached/detached to/from devices, such as a magnetic tape, a magnetic disk (e.g., a floppy disk and a hard disk drive), an optical disk (e.g., a CD-ROM and a DVD), a magneto-optical disk (e.g., a MO), and a flash memory, and those media which can be transferred via a network.

What is claimed is:

1. An interface board for connecting a CPU board and a peripheral hardware simulator with each other, the CPU board having at least one CPU, the peripheral hardware simulator simulating operation of at least one peripheral hardware component by a peripheral hardware model, and the interface board comprising:
a wait instruction unit that receives an interruption notification from the CPU, then notifies the peripheral hardware model of the interruption notification, and sets the CPU into a wait state; and
a release unit that releases the wait state in which the CPU has been set by the wait instruction unit, upon reception of an instruction to release the wait state from the peripheral hardware model which has been notified of the interruption notification.

2. The interface board according to claim 1 further comprising a dual port memory which is accessible from the CPU board and the peripheral hardware simulator, wherein
upon access to a predetermined area in the dual port memory, the wait instruction unit notifies the peripheral hardware model of the interruption notification and sets the CPU into the wait state.

3. The interface board according to claim 1, wherein
the interface board is connected to the peripheral hardware simulator by a PCI bus.

4. A simulator comprising:
a CPU board that has at least one CPU;
a peripheral hardware simulator that simulates operation of at least one peripheral hardware component by a peripheral hardware model;
a wait instruction unit that receives an interruption notification from the CPU, then notifies the peripheral hardware model of the interruption notification, and sets the CPU into a wait state; and
a release unit that releases the wait state in which the CPU has been set by the wait instruction unit, upon reception of an instruction to release the wait state from the peripheral hardware model which has been notified of the interruption notification.

5. The simulator according to claim 4 further comprising a dual port memory which is accessible from the CPU board and the peripheral hardware simulator, wherein
upon access to a predetermined area in the dual port memory, the wait instruction unit notifies the peripheral hardware model of the interruption notification and sets the CPU into the wait state.

6. The simulator according to claim 4, wherein
the wait instruction unit and the release unit are connected to the peripheral hardware simulator by a PCI bus.

7. A synchronization method for synchronizing a CPU and at least one peripheral hardware model with each other, the at least one peripheral hardware model modeling a peripheral hardware component as a software component, and the synchronization method comprising:
a wait instruction step that, upon reception of an interruption notification from the CPU, notifies the peripheral hardware model of the interruption notification and sets the CPU into a wait state; and
a release step that releases the wait state in which the CPU has been set in the wait instruction step, upon reception of an instruction to release the wait state from the peripheral hardware model which has been notified of the interruption notification.

8. The synchronization method according to claim 7, wherein
the wait instruction step notifies the peripheral hardware model of the interruption notification and sets the CPU into the wait state, upon access to a predetermined area in a dual port memory which is accessible from a CPU board including the CPU and from a peripheral hardware simulator causing the peripheral hardware model to work.

9. The synchronization method according to claim 7, wherein
the wait instruction step and the release step are executed by an interface board which connects the CPU board including the CPU and the peripheral hardware simulator causing the peripheral hardware model to work with each other, and the interface board is connected to the peripheral hardware simulator by a PCI bus.

10. A synchronization program for causing a computer to execute a synchronization processing for synchronizing a CPU and at least one peripheral hardware model with each other, the at least one peripheral hardware model modeling a peripheral hardware component as a software component, and the synchronization program comprising:
a wait instruction step that, upon reception of an interruption notification from the CPU, notifies the peripheral hardware model of the interruption notification and sets the CPU into a wait state; and
a release step that releases the wait state in which the CPU has been set in the wait instruction step, upon reception of an instruction to release the wait state from the peripheral hardware model which has been notified of the interruption notification.
